(19) United States
(12) Patent Application Publication
(10) Pub. No.: US 2013/0188372 A1
(43) Pub. Date: Jul. 25, 2013

(54) LIGHT EMITTING DIODE LAMP

(71) Applicant: Karen Ludvigovich Petrosyan, Yerevan (AM)

(72) Inventor: Karen Ludvigovich Petrosyan, Yerevan (AM)

(21) Appl. No.: 13/519,911

(22) PCT Filed: Dec. 29, 2010
(86) PCT No.: PCT/RU10/00799

§ 371 Date: Sep. 20, 2012

(30) Foreign Application Priority Data
Dec. 31, 2009 (RU) 2009149598

(51) Int. Cl. F21V 29/00

(52) U.S. Cl. CPC F21V 29/2206
USPC 362/382

(57) ABSTRACT

The light-emitting diode lamp comprises a heat sink with a hollow central part, radial-longitudinal fins forming an outer circuit of the lamp, the LEDs placed so as to ensure the possibility of direct contact heat transfer to the heat sink at an annular pad, ends of the radial-longitudinal fins being connected to the annular pad.

### FIELD OF THE INVENTION

The invention relates to illumination devices, in particular, to light-emitting diode lamps (luminaires, illuminants) intended for illumination of industrial, public, office and accommodation rooms and spaces.

### BACKGROUND INFORMATION

As compared to conventional electric light sources (incandescent, fluorescent, gas-discharge halogen, sodium, mercury, etc. lamps), light-emitting diodes group with light sources that feature the highest levels of luminous efficiency (up to 150 mm/W) at a 10 to 20 percent power consumption (in comparison to conventional incandescent lamps).

An LED lamp on the basis of high-power light-emitting diodes is an energy-efficient, environmentally safe, long-life light source.

The principal indicator of the efficiency of an illumination lamp is its luminous efficiency measured in [lm/W], i.e the luminous flux in lumens per unit electric power consumed (in W).

A standard LED lamp with light-emitting diodes comprises also some secondary optics (reflectors, optical lenses), a heat sink, and a power source.

Each of the above components affects, in their combination, the resulting luminous efficiency, as well as reliability and service life of the LED lamp.

In the course of time, a high temperature or the crystal (light-emitting element) gives rise, under conditions of inadequate heat dissipation, to accelerated degradation of the crystal, changes in color rendering and a decrease in the light flux, and as a result, to a shortened service life of an LED lamp.

Therefore, at certain values of power source and optical lens efficiencies, the luminous efficiency can be improved through decreasing the temperature of the diodes, that is, through raising the efficiency of cooling the light-emitting elements of the diodes. Ensuring optimal heat conditions of a light-emitting diode is the principal problem in the way towards utmost luminous efficiency, reliability and service life of LED lamps.

In all the types of LED lamps known at the present time, the thermal model is employed which accounts for dissipation of heat from the light-emitting diode to the heat sink, and natural (i.e. in the absence of forced-air cooling) convective heat transfer from the heat sink to the ambience. Parameters of required heat dissipation are determined basically by the design of the heat sink.

The LRP-38 LED lamp manufactured by the CREE company (USA) is known (www.creells.com/Irp-38.htm). It features an E-26/27 type screw cap for connection to an external a.c. power source, a tapered metal heat sink longitudinally finned on the outside, and a light-emitting diode disposed in an LED lens. A shortcoming of such a lamp is a low-efficiency convection system as the heat sink is cooled down solely through its outside finning.

Also, CREE's LR6 LED lamp (www.creells.com) is known. The lamp features a hollow metal cylindrical heat sink that consists of two parts and has longitudinal finning on the outside. The above parts are interconnected through a thermal insert. Light-emitting diodes are placed on a printed-circuit board connected to the heat sink inside which a power source is disposed. Drawbacks of the lamp are a low-efficiency system of dissipation of heat from an LED via the metal base of the PCB to a massive aluminum heat sink, with convective heat transfer to the ambience solely through the outside finning of the heat sink, and the availability of the thermal insert in between the sink parts. Additionally, on the side of LED emitters, the PCB has a sputtered coating to ensure an adequate sealing of the LEDs and their current-conducting strips.

SHARP's DL-D007N LED lamp (http://sharp-world.com/corporate/news/080804_{—}1.html) is a device most similar to the claimed LED lamp by its technical substance. It has a cylindrical housing with light-emitting diodes in optical lenses disposed inside thereof on printed circuit boards. Outside, on the plane of the cylindrical housing accommodating LED modules in optical lenses on PCBs, a heat sink is placed, rigidly coupled to the housing. The heat sink consists of longitudinal parallel fins normal to the common inner wall. Above the fins, a plane for distribution of heat flows from the heat sink is arranged. Shortcomings of the afore-described LED lamp design are as follows:
a low efficiency of heat transfer from a light-emitting diode via the PCB to the housing/heat sink;
a low intensity of convective cooling flows to the ambience;
the availability of the plane in the upper part of the heat sink, which slows down the speed of the cooling longitudinal convective flows.

In all the LED lamp designs above, a printed circuit board on an aluminum substrate (MCP CB) is used for fixation of the LEDs and electric connection of the diodes with a power source, as well as for heat transfer to the housing/heat sink. Such boards feature lowest thermal resistance values (3.4 K/W). Designs of LED modules for LED lamps comprise a light-emitting diode with electric connections arranged on a printed circuit board, and an optical lens with an LED crystal therein. For protection against moisture, the points of soldered connections of the LED to the PCB are covered with lacquer and (or) compound materials.

### DESCRIPTION OF THE INVENTION

The technical result according to the invention claimed is the creation of a LED lamp with such a heat sink design which allows natural fast-moving convective flows, and an LED module design and a way of LED module fixation to the heat sink, which, when combined, ensure optimal heat conditions of each LED and the LED lamp as a whole (with allowance for heat cycling) without a decrease in the luminosity for the entire period of the life cycle. When doing so, the attachment of an LED to the heat sink must ensure a reliable thermal contact.

The overall heat transfer resistance in the heat circuit of the lamp is determined by the type of the LED, thermal performance of the LED-to-sink coupling assembly, and heat convection from a heat sink appropriate for the LED lamp in question to the air ambience.

The heat transfer resistance of the LED proper (between the light-emitting element and the heat-dissipating base of the LED housing) is a characteristic that depends on the type of the LED and therefore this quantity should be dropped when evaluating the overall efficiency of the heat-dissipating system of a specific lamp.

Nominal sizes of LED lamps correspond to those of incandescent lamps, which restrict their geometrical parameters, and determine, for the greater part, the shape and dimensions of the heat-dissipating system, in particular, those of the LED lamp heat sink.

Heat dissipation is improved in the case of vertical arrangement of active surfaces of the heat sink as such geometry facilitates convection (favoring the origination of additional heat flows and their velocities).

The above technical result is achieved in an LED lamp comprising a heat sink with a hollow central part, radial-longitudinal fins forming an outer circuit of the lamp (heat sink) while the LEDs are disposed so as to ensure contact transfer of heat to the sink at an annular pad made in the heat sink end part, the ends of the radial-longitudinal fins being connected to the annular pad.

The heat sink can be made with an outer wall adjacent to the ends of the embraced radial-longitudinal fins connected to the annular pad positioned with a gap relative to the outer wall.

The heat sink can be made with an inner wall connected to the annular pad and crossing the radial-longitudinal fins.

The LEDs can be placed so as to allow contact transfer of heat to the heat sink at two or more annular pads at the end part of the sink. In particular, the annular pads can be arranged with a gap relative to each other, for instance, concentrically.

The heat sink can be made with inner walls, each being contiguous to one of the annular pads and crossing the radial-longitudinal fins.

Each LED can be fixed on a plate placed, in its turn, on an annular pad of the heat sink. In this case, the heat conductivity of the material of the plate is higher than that of the heat sink.

The power source of the lamp can be disposed within the central hollow part of the heat sink with a gap relative to the neighboring radial-longitudinal fins of the heat sink.

The lamp can comprise additionally a printed circuit board (PCB) on an annular pad for connection of the LEDS to the power supply source. The PCB can be made with cut-outs where LEDs or plates of higher heat conductivity and LEDs are placed.

This technical result is achieved in the LED lamp heat sink made with radial-longitudinal fins forming an outer circuit of the heat sink, a hollow central part, and an annular pad for the LEDs at the end part of the heat sink, the ends of the radial-longitudinal fins being connected to the annular pad.

The heat sink can be fabricated with an outer wall adjacent to ends of the embraced radial-longitudinal fins connected to the annular pad arranged with a gap relative to the outer wall.

The heat sink can be made with an inner wall connected to the annular pad and crossing the radial-longitudinal fins.

At the end part of the heat sink, two or more annular pads can be provided for, connected to ends of the radial-longitudinal fins and arranged, in particular, concentrically and with a gap to each other.

### BRIEF DESCRIPTION OF THE DRAWINGS

FIG. 1 is a general view of the LED lamp.

FIG. 2 presents the LED lamp design in an orthogonal lateral projection with a vertical section of the heat sink.

FIG. 3 presents a view of the LED lamp as viewed from the side of the LED modules.

FIG. 4 presents the LED lamp design at the LED point.

### PREFERABLE EMBODIMENTS OF THE INVENTION

Referring to FIG. 1, an LED lamp is schematically depicted, which comprises a heat sink 1 being a hollow figure of rotation, with radial-longitudinal fins 2 in the periphery of the heat sink, an annular pad 3 connected to ends of the fins 2; an outer wall 4 adjacent to ends of the fins 2 from the side of the pad 3; an inner wall 5 connected to the annular pad 3 and crossing the fins 2; a power source 6 in the hollow central part of the heat sink 1; a cap screw 7; light-emitting diodes 8; copper plates 9; a printed circuit board 10, and diffusers 11.

The lamp can be equipped with a cover 12 put on the heat sink 1 on the side of the LEDs 8 and made perforated on both end and side faces for the purpose of free passage of convection heat flows. The cover 12 is a component to protect against any contact to current-carrying elements of the LED lamp and prevent from physical damage of the LED modules of the lamp. Also, the cover adds to the styling design of the LED lamp on the whole.

An example of the embodiment of the LED lamp comprises six light-emitting diodes 8, however their number may vary (being more or fewer than six).

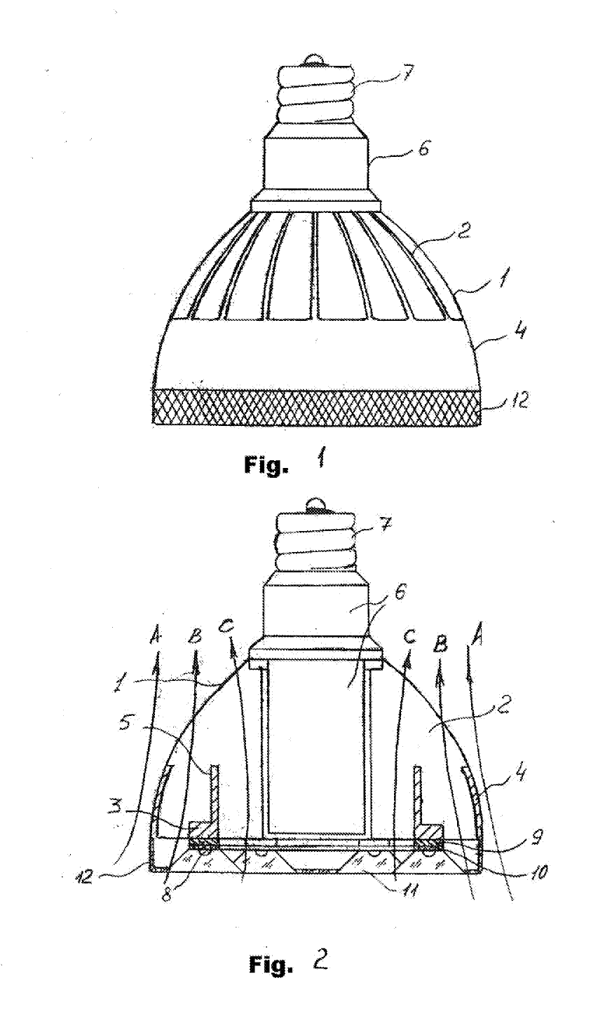

Referring to FIG. 2, the LED lamp design is displayed in an orthogonal lateral projection with a vertical section of the heat sink 1, and the perforated cover 12 (shown with dotted lines).

The shape of the heat sink is tapered. It widens towards one end where the LEDs are placed and narrows towards the opposite end where the power source is positioned.

The number of the fins 2, their thickness and spacing between neighboring fins are chosen on the basis of numerical calculations to ensure the utmost efficiency of heat dissipation depending on the number of the LEDs 8.

FIG. 3 presents a view of the heat sink 1 of the LED lamp as viewed from the side of the LED modules. The power source 6 is placed in the hollow portion of the heat sink. The housing of the power supply source is made of plastic. The LEDs 8 are connected in series, yet they may be connected in parallel or as a certain combination.

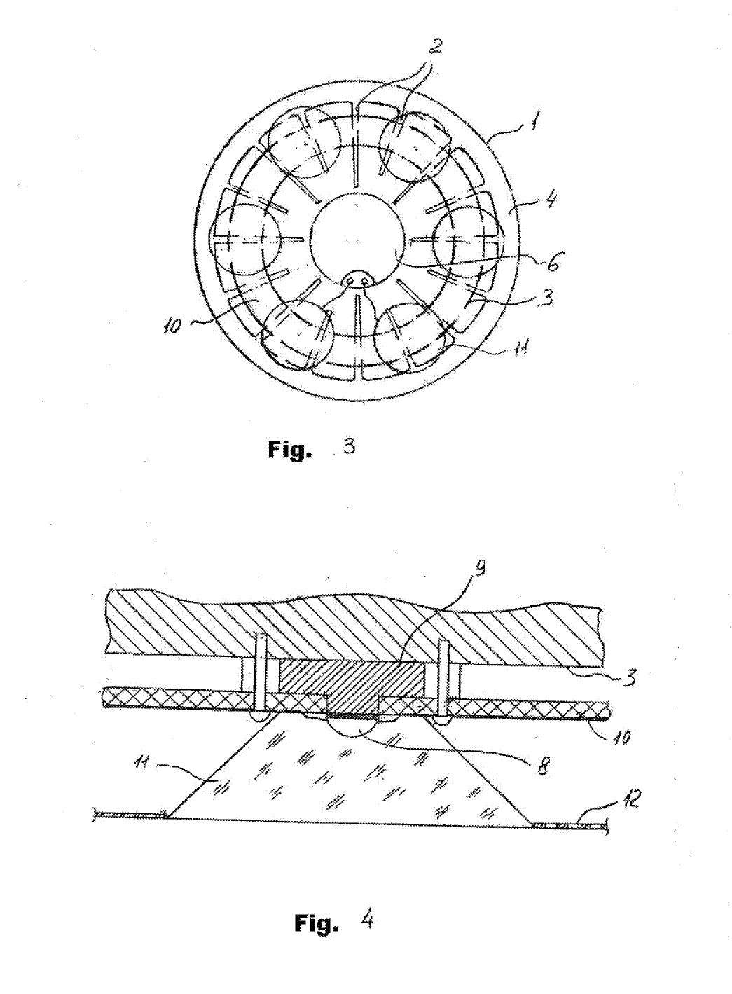

FIG. 4 presents the LED lamp design at the LED point. Terminal leads of a light-emitting diode are connected to conductors of the printed circuit board 10. A heat-dissipating plate 9 is made of copper and placed beneath the PCB 10, with a projection (in a hole made in the PCB 10) in contact with the non-conductive LED housing, by means of melting the solder alloy through heating the heat-dissipating plate.

The heat sink 1 can be fabricated by press molding of aluminum alloy. Number, thickness and surface area of the outer heat-dissipating fins 2 and the inner heat-dissipating fins 7 depend on the power of the LEDs 8 while the shape of the heat sink is determined by the nominal size of the LED lamp as per Standard PAR 38. The heat sink 1 can be a pre-fabricated component. For instance, the annular pad 3 and the inner wall 5 can be made by press molding of aluminum alloy while the rest of the heat sink is fabricated of plastic.

Mating surfaces of the copper heat-dissipating plate 9 and the annular pad 3 forming part of the aluminum-alloy heat sink 1 are made to a high geometrical precision and high surface finish characteristics, which ensures a minimal heat transfer resistance at the interface. The optical lens 11 can be placed onto LED 8 after the LED is fixed on the heat sink 1.

The geometrical dimensions of the copper heat-dissipating plate 9 are determined using some numerical calculation methods known to those skilled in the art, and should match up the width of the annular pad 3.

The LED lamp claimed ensures optimal heat conditions for high-power LEDs 8 in the following way.

Heat from the LED 8 is transferred, via the copper heat-dissipating 9 and the annular pad 3, to the aluminum-alloy heat sink 1, which is heated up and forms natural separated unidirectional convective flows passing through the perforated cover 12 under different temperature and velocity conditions (one inner flow, C, via the hollow central part, and two outer flows, namely, B in between the pad 3 and the outer wall 4, and A exterior to the outer wall 4), which ensure an efficient removal of heat from the housing/heat sink 1.

The positive effect is achieved owing to a comprehensive design & technology solution of the LED lamp as a whole and the design of the housing/heat sink 1 in particular.

At the nominal power of the LED 8, the difference between the temperature of the copper heat-dissipating plate 9 and that of the aluminum-alloy heat sink 1 in the LED lamp as claimed is no higher than 0.5° C. In CREE's top-of-the-line LED lamps (universally recognized as pertaining to the best LED lamp products worldwide), the afore-said temperature difference is no less than 1.0° C.

The overall heat transfer resistance of the claimed LED lamp at an LED energy dissipation of 1.3 W is around 10.6° C./W. Thus, in the LED lamp claimed, high-power LEDs can be used with an increase in their brightness through a decrease in the temperature of the LED 8 at a stable maximal luminous efficiency with stable maintenance of the color temperature (e.g., 2,700K).

The LED lamp as claimed meets, to the fullest extent, the following consumer requirements:
power (luminous flux, brightness);
reliability (service life);
energy-saving performance (energy consumption);
cost.

The claimed invention is a preferable, yet non-exhaustive, design example of the embodiment of a PAR-38 LED lamp as presented graphically in FIGS. 1-4.

What is claimed is:

1. A light-emitting diode lamp wherein a heat sink is made with radial-longitudinal fins forming an outer circuit of the lamp, and a hollow central part, while the light-emitting diodes are disposed so as to provide the possibility of direct contact heat transfer to the heat sink at an annular pad made at the end part of the heat sink, ends of the radial-longitudinal fins being connected to the annular pad.

2. The lamp of claim 1 wherein the heat sink is made with an outer wall adjacent to ends of the embraced radial-longitudinal fins connected to the annular pad having a gap relative to the outer wall.

3. The lamp of claim 1 wherein the heat sink is made with an inner wall connected to the annular pad and crossing the radial-longitudinal fins.

4. The lamp of claim 1 wherein the light-emitting diodes are positioned so as to ensure direct contact heat transfer to the heat sink via two or more annular pads provided for at the heat sink end.

5. The lamp of claim 4 wherein the heat sink is made with inner walls, each adjacent to one of the annular pads and crossing the radial-longitudinal fins.

6. The lamp of claim 1 wherein each light-emitting diode is mounted on a plate placed, in its turn, on the annular pad of the heat sink, the heat conductivity of the material of the plate being higher than that of the heat sink.

7. The lamp of claim 1 wherein the power source is disposed in the central part of the heat sink with a gap relative to the neighboring radial-longitudinal fins of the heat sink.

8. The lamp of claim 1 wherein it comprises additionally a printed circuit board at the annular pad for connection of the light-emitting diodes to the power source.

9. A heat sink for the LED lamp wherein it is fabricated with radial-longitudinal fins forming an outer circuit of the lamp, a hollow central part, and an annular pad at the end of the heat sink, ends of the radial-longitudinal fins being connected to the annular pad.

10. The heat sink of claim 9 wherein it comprises an outer wall adjacent to ends of the embraced radial-longitudinal fins connected to the annular pad having a gap relative to the outer wall.

11. The heat sink of claim 9 wherein it is made with an inner wall connected to the annular pad and crossing the radial-longitudinal fins.

12. The heat sink of claim 9 wherein it is made with two or more annular pads at the end of the heat sink, the pads being connected to the radial-longitudinal fins.
